(19) United States
(12) Patent Application Publication
(10) Pub. No.: US 2016/0293927 A1
(43) Pub. Date: Oct. 6, 2016

(54) Battery Cell for a Battery and Method for producing a Battery Cell

(71) Applicant: Robert Bosch GmbH, Stuttgart (DE)

(72) Inventors: Alexander Schmidt, Donaueschingen (DE); Joerg Poehler, Korntal-Muenchingen (DE)

(21) Appl. No.: 14/778,056

(22) PCT Filed: Feb. 21, 2014
(86) PCT No.: PCT/EP2014/053450

§ 371 Date: Sep. 17, 2015

(30) Foreign Application Priority Data
Mar. 18, 2013 (DE) 10 2013 204 675.8

(51) Int. Cl. H01M 2/26; H01M 2/30; H01M 10/04; H01M 10/613; H01M 10/653; H01M 10/654; H01M 10/6553; H01M 10/625; H01M 10/0525; H01M 10/0587

(52) U.S. Cl. CPC H01M 2/263; H01M 10/0525; H01M 2/30; H01M 10/0431; H01M 10/0587; H01M 10/653; H01M 10/654; H01M 10/6553; H01M 10/625; H01M 10/613; H01M 2220/20

(57) ABSTRACT

A battery cell for a battery is arranged in a housing. The battery cell includes a coil having a first connection and a second connection. The battery cell further includes a contact element between the second connection of the coil and the housing. The contact element is an electrical and a thermal conductor or an electrical insulator and a thermal conductor for connecting the coil to the housing. The contact element has a cross section which is greater than a cross section of the first connection and/or which is configured to conduct a flow of heat, which is dependent on an energy store density of the coil, in a predetermined time from the coil, via the contact element, to the housing. The second connection is electrically insulated from the first connection.

### PRIOR ART

The present invention relates to a battery cell for a battery and to a method for producing a battery cell.

High-voltage energy stores with large capacity, for example for the drive for electric vehicles, are generated with the series connection of electrochemical cells. Due to their high energy density, lithium-ion batteries are currently the preferred solution. A disadvantage of lithium-ion cells is their potential to catch fire and/or explode in the event of over-discharge or deep discharge. A safety-critical state is brought about typically by an internal short circuit, which, if a limit temperature of 130° C.-170° C. is overshot, leads to an exothermic reaction—generally referred to as “thermal runaway”. Here, active materials and the electrolyte are oxidized. The typical thermal output lies in the kW range, whilst the reaction is generally completed within a period of time of less than 30 seconds (t<30s). Further cells can be “plugged on” subsequently due to the reaction heat. Externally there may be a development of smoke or fire at the battery cell in addition to a temperature progression of T>200° C., and in some cases explosions have even been reported. In order to prevent the above-described thermal runaway, various safety measures are known. A monitoring of the cell voltage is thus mandatory during operation. Furthermore, the battery cells can be provided for example with melt separators, which prevent the ion flow and current flow above a defined temperature. A complete listing of all known safety mechanisms and apparatuses is spared at this juncture.

In accordance with the general state of knowledge, a feature common to all measures that are taken following an internal short circuit is that they do not quantitatively guarantee the prevention of a thermal runaway.

### DISCLOSURE OF THE INVENTION

On this basis the present invention presents a battery cell for a battery and a method for producing a battery cell according to the main claim. Advantageous embodiments will emerge from the dependent claims and the following description.

It is possible to prevent an exothermic reaction of a coil of a battery cell from spreading to adjacent coils when an appropriate quantity of heat can be removed from the coil of the battery cell within an appropriate time, such that an adjacent coil does not exceed a predetermined limit temperature and therefore does not enter a safety-critical state.

A battery cell for a battery, wherein the battery cell is arranged in a housing, comprises:

a coil having a first connection;

a contact element between a second connection of the coil and the housing, wherein the contact element is formed as an electrical and a thermal conductor or as an electrical insulator and a thermal conductor for connecting the coil to the housing, wherein the contact element has a cross section which is greater than the cross section of the first connection and/or which is designed to conduct a flow of heat, which is dependent on an energy storage density of the coil, in a predetermined time from the coil, via the contact element, to the housing, wherein the second connection is electrically insulated from the first connection.

In the present case a method for producing a battery cell for a battery is also presented, wherein the battery cell is arranged in a housing, wherein the method comprises the following steps:

providing a coil, which has a first connection; and

arranging a contact element between a second connection of the coil and the housing, wherein the contact element is formed as an electrical and a thermal conductor for connecting the coil to the housing, wherein the contact element has a cross section which is greater than the cross section of the first connection and/or which is designed to conduct a flow of heat, which is dependent on an energy storage density of the coil, in a predetermined time from the coil, via the contact element, to the housing, wherein the second connection is electrically insulated from the first connection.

A vehicle may have a battery. The vehicle may be a car, in particular a passenger car or a utility vehicle. A battery can be understood to be an accumulator. The battery may have at least one battery cell. When a plurality of battery cells are used in a battery, these can be connected in parallel and/or in series. The battery cell may be a lithium-ion battery cell with a high energy density, as can be provided for example using NCM or manganese spinel as electrode material, in particular cathode material. Furthermore, the at least one battery cell may have at least one coil. The battery cell may have electrodes in the coil. The functional structure may be similar to a sandwich, i.e. a positive current collector, a cathode, a separator, an anode and a negative current collector can be stacked. The resultant assembly can be wound, stacked or the like, depending on the desired construction of the cell. The current collectors should then be connected externally to the pole connections of the cell. The anode and cathode are electrically insulated by the separator. The latter is porous and is penetrated by electrolyte, in which ions are dissolved. The anode and cathode are thus connected via ion conduction, thus giving the name “lithium-ion cell”. An electrical flow of current through a consumer at the poles of the cell is induced by the potential difference of the charged electrodes. Conversely, when a charging voltage is applied, the ion flow is inverted and the potential difference between anode and cathode is increased again. This potential difference or also terminal voltage of the cell is dependent on the stored charge and therefore on the number of ions incorporated into the electrodes. This can be referred to as a coil when the resultant assembly is wound. A battery cell may have a plurality of coils. A safety element can decouple the coil from the battery cell and/or the battery in the event of a short circuit and/or overcharging and/or deep discharge and/or in the event that a critical temperature is reached. The safety criterion may thus signify the overshoot and/or undershoot of a threshold value. For this purpose, a temperature, an intensity of current or an intensity of voltage can be monitored by way of example and compared with a corresponding threshold value. The decoupling of the coil can be understood to mean an interruption of an electrical connection between a connection of the coil and a connection contact of the battery cell. The first connection of the coil and the second connection of the coil may have a different polarity. The connections of the coil, i.e. the first connection and/or the second connection, may be made of metal. The second connection is connected via a contact element to the housing of the battery cell. The contact element may be part of the second connection. The contact element may be part of the housing. A flow of heat can be conducted from the coil to the housing via the contact element and/or the second connection. The housing can be designed to have a function as a heat sink and/or to dissipate thermal energy to the surrounding environment. The housing of the battery cell may forward a flow of heat to a housing of the battery.

An embodiment of the present invention in which a thermally conductive, but electrically insulating contact element with a cross section is additionally provided at the first connection and the first connection is designed to conduct a flow of heat, which is dependent on an energy storage density of the coil, from the coil, via the contact element, to the housing, wherein the second connection is electrically insulated from the first connection, is particularly advantageous. Such an embodiment of the present invention offers the advantage of a particularly quick possibility for the discharge of heat produced in the coil.

In accordance with a particular embodiment of the present invention a safety element associated with the coil may be provided, which safety element is designed to electrically decouple the first connection of the coil from the battery cell when a predetermined safety criterion is met. Such an embodiment of the present invention offers the advantage of a particularly safe battery cell, since in the event of a fault, in particular in the event that the safety criterion is met, an electrical decoupling of the electrical voltage from the first connection is ensured, such that a short circuit can be prevented, for example.

Furthermore, the at least one battery cell may have at least one second coil. The at least two coils can be connected to one another electrically in parallel.

In one embodiment the at least one battery cell can be designed as a prismatic battery cell and/or the coil can be designed as a prismatic coil. Electrodes and separators of the battery cells can be wound prismatically. The at least one coil of the battery cell can be wound prismatically. Advantages of a coil can thus be combined with a prismatic construction.

In accordance with one embodiment the first connection of the coil can be formed from a first material and the second connection of the coil can be formed from a second material different from the first material. An ion flow takes place in the coil assembly or in the coil, between the electrodes.

The second connection of the coil and the housing of the battery cell may also have the same material properties, in particular may consist at least in part of the same material. The second connection and the housing can be fabricated from the same material. The material of the second connection and the housing may have the same electrical and/or thermal properties. The contact element between the second connection and the housing can thus be formed from the same material. A continuous or uniform thermal conductivity from the second connection, via the contact element, to the housing can be provided by the use of the same material.

It is also favorable when the housing of the battery cell and at the same time or alternatively the second connection of the at least one coil comprises aluminum or an aluminum alloy and at the same time or alternatively the first connection of the at least one coil comprises copper or a copper alloy. Aluminum may have a suitable thermal conductivity value.

An embodiment of the present invention in which a flow of heat that can be conducted via the contact element in a predefined time corresponds to an energy released with oxidation of the contents of the battery cell, at least within a tolerance range, is also favorable. The at least one coil of the battery cell may have an energy storage capacity. The energy capacity stored in the coil can be demanded as an electrical energy, particularly during normal operation. The rated capacity of the coil can be understood to mean the stored electrical energy at rated voltage. The energy of the coil released by an exothermic reaction may be less than the rated capacity of the battery cell of the coil. The energy can be released in a predetermined time interval in the event of an exothermic reaction. The time interval or the predefined time may lie in a time window from ten to thirty seconds. The flow of heat may correspond to a quantity of heat corresponding to the rated capacity of the coil. The quantity of heat can be conducted from the coil to the housing of the battery cell in a time shorter than thirty seconds. Here, the heat transfer can be influenced by the thermal conductivity of the material of the coil, of the contact element or of the housing of the battery cell and by the cross section of the contact element or of the second connection.

Furthermore, the second connection may have a larger cross section than the first connection. A quantity of heat can be transferred to the housing of the battery cell via the second connection. With a larger cross section a larger quantity of heat can be transferred in the same time than with a comparatively smaller cross section. More heat energy can be conducted away from the coil via the second connection than via the first connection, and therefore it may be advantageous to provide a larger cross section of the connection.

Furthermore, the safety element can be designed as a melt separator. A safety element can be understood to mean a safety mechanism or a safety device.

In accordance with one embodiment a first connection contact of the battery cell can be electrically connected to the first connection of the at least one coil and/or a second connection contact of the battery cell can be electrically connected to the housing and/or the second connection of the at least one coil. Here, the first connection contact and the second connection contact can be electrically insulated from one another.

Furthermore, the housing of the battery cell or at least a side face of the housing of the battery cell can be formed as a cooling face or heat sink of the battery cell. In the event of an exothermic reaction of the at least one coil, a quantity of heat can be conducted from the coil to the housing. If at least one side face of the housing is designed as a cooling face or as a heat sink, a quantity of heat can be dissipated from the housing to the surrounding environment or an arbitrary cooling medium, in particular the ambient air.

It is also favorable if at least one further coil is arranged in the housing and is connected electrically parallel to the at least one coil: here, in particular a first connection of the at least one further coil is electrically connected to the first connection of the at least one coil. A second connection of the at least one further coil is electrically connected to the second connection of the at least one coil. In order to increase the power of the battery cell, two or more coils can be combined in one battery cell. A plurality of coils can be connected to one another in parallel. A plurality of coils can be connected to one another in series. A combination of series and parallel connection can also be provided. In the case of a parallel connection of coils, each coil can be protected by means of a safety element. In the event of a failure of one coil, the rest of the battery cell can thus continue to provide electrical energy.

In order to increase the power of a battery, two or more battery cells can be combined in one battery. A plurality of battery cells can be connected to one another in parallel. A plurality of battery cells can be connected to one another in series. Battery cells connected in series can be referred to as a battery cell strand. A combination of series and parallel connection can also be provided. In the event of a parallel connection of battery cells, each battery cell or each battery cell strand arranged in parallel can be protected by means of a safety element. In the event of a failure of one battery cell or of a battery cell strand, the rest of the battery can thus continue to provide electrical energy.

The battery cell may be a safe battery cell in accordance with the ASIL standard. Here, ASIL stands for “automotive safety integrity level” and specifies a safety requirement level for safety-relevant systems in motor vehicles.

One aspect of the presented battery cell is a cell design for prismatic large cells having one or more coils, wherein what is known as thermal runaway can be prevented. It is thus possible to also use electrode materials of high energy density, such as NCM, which have proven to be difficult to control, in automotive applications. Furthermore, a battery cell can be assessed in accordance with functional safety criteria. In accordance with ASIL D, an individual fault, in particular of a battery cell or of a winding, must not lead to the failure of the battery or vehicle battery.

In other words, a battery cell can have a flat thermal attachment of the second connection of the coil to the housing of the battery cell. The second connection may be a positive aluminum current collector of coils of a battery cell, in particular a prismatic lithium-ion cell. Here, the coil size can be adapted to the thermal adaptation. The safety element, which for example is formed as a switch, can interrupt a current. A further energy feed is thus interrupted, such that the internal short circuit, once occurred, can no longer influence the power output. In this case heat should be discharged in order to maintain a temperature of T<130° C.

One embodiment of the present invention offers the advantage that the energy density can be increased by up to 30% to 200 Wh/kg for cars using known electrode materials. Furthermore, intrinsically safe battery cells and battery modules can be used, which can also operate safely in the event of failure of the monitoring electronics. Battery cells can thus also be designated as ASIL D-capable. A presented battery advantageously allows an increased availability, and therefore continued driving may be possible even in the event of a fault.

The invention will be explained in greater detail hereinafter by way of example on the basis of the accompanying drawings, in which:

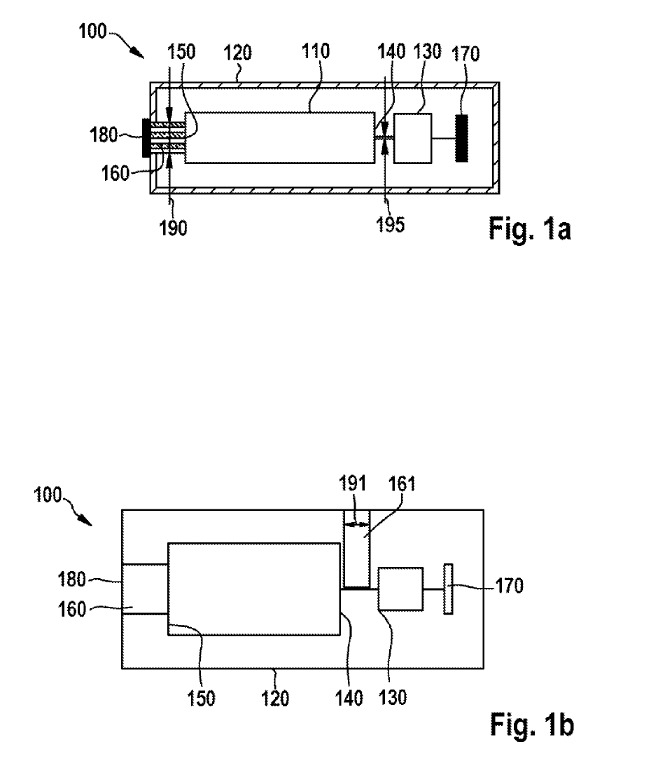

FIG. 1A shows a schematic illustration of a battery cell in accordance with an exemplary embodiment of the present invention;

FIG. 1B shows a schematic illustration of a further battery cell in accordance with an exemplary embodiment of the present invention;

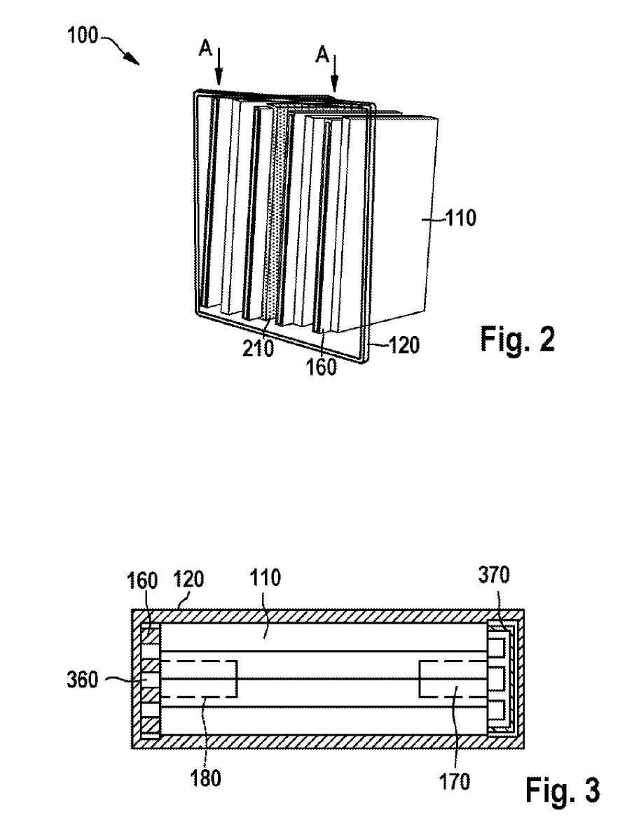

FIG. 2 shows a schematic illustration of a prismatic battery cell having four cell coils in accordance with an exemplary embodiment of the present invention;

FIG. 3 shows a schematic illustration of a prismatic battery cell having four cell coils in accordance with an exemplary embodiment of the present invention;

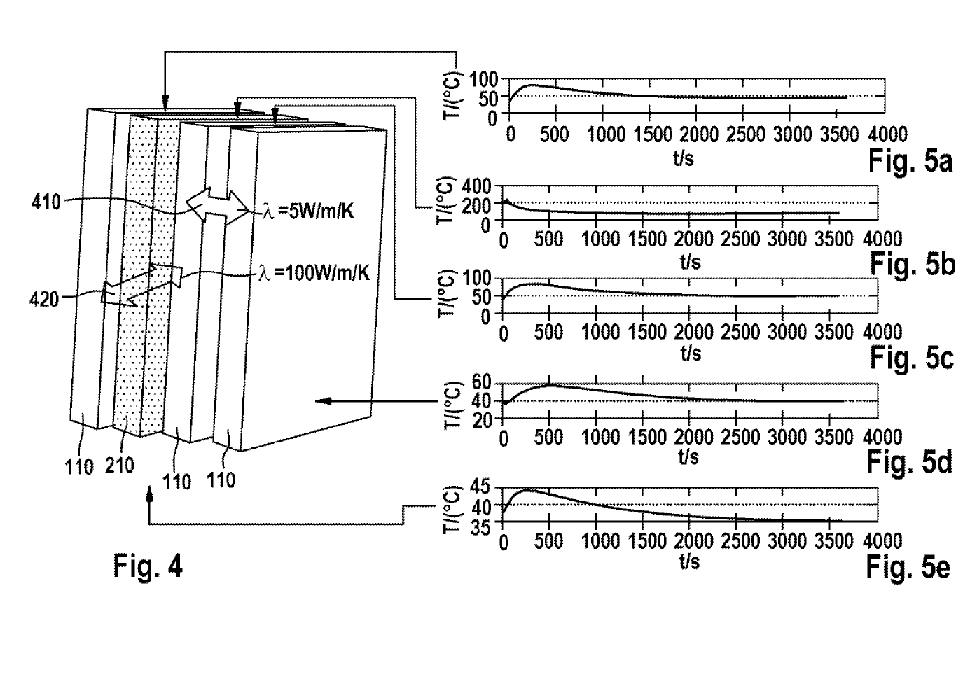

FIG. 4 shows a schematic illustration of a prismatic battery cell having four cell coils, wherein one cell coil has an internal short circuit, in accordance with an exemplary embodiment of the present invention;

FIG. 5a to FIG. 5e show a simulated temperature profile for the battery cell shown in FIG. 4 in accordance with an exemplary embodiment of the present invention; and

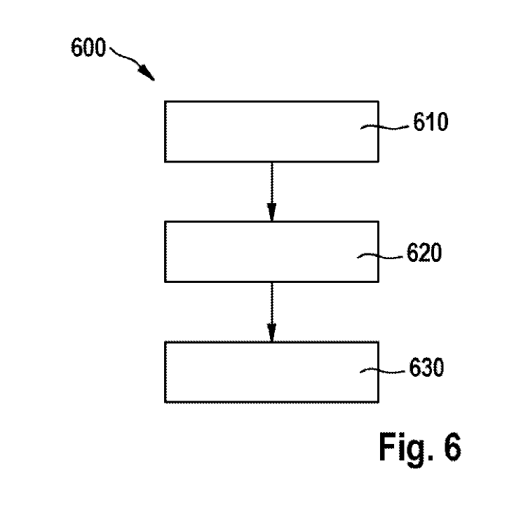

FIG. 6 shows a flow diagram of an exemplary embodiment of the present invention as a method.

In the following description of preferred exemplary embodiments of the present invention, like or similar reference signs will be used for similarly acting elements illustrated in the various figures, wherein a repeated description of these elements is spared.

FIG. 1A shows a schematic illustration of a battery cell 100 in accordance with an exemplary embodiment of the present invention. The battery cell 100 may be a battery cell for a vehicle battery. The battery cell 100 has a coil 110, which is arranged in a housing 120. A safety element 130 is arranged on a first connection 140 of the coil 110. The coil 110 has a second connection 150. The second connection 150 is connected to the housing 120 via a contact element 160. The battery cell 100 has a first connection contact 170 and a second connection contact 180. The connection contacts 170 and 180 can also be referred to as poles of the battery cell. The first connection contact 170 is connected to the first connection 140 of the coil 110 via the safety element 130. When the safety element 130 is triggered, the electrical connection between the first connection 140 and the first connection contact 170 of the battery cell 100 can thus be separated. The second connection 150 of the coil 110 is electrically and thermally coupled to the housing 120 of the battery cell 100 via the contact element 160. Furthermore, the second connection 150 is electrically coupled to the second connection contact 180 of the battery cell 100 via the contact element 160. The first connection contact 170 and the second connection contact 180 are insulated from one another.

Even if the contact element 160 is an electrical insulator, the connection 150 and the pole 180 should be electrically connected; at the same time, the first connection 140 should also be electrically connected to the first connection contact 170.

In a state of the battery cell 100 ready for operation, the first connection contact 170 and the second connection contact 180 have a different polarity. The connection between the coil 110 and the housing 120 formed by the second connection 150 and the contact element 160 has a cross-sectional area 190. In the case of a cross-sectional area that is variable over the length of the connection, the cross-sectional area 190 can be understood to mean the smallest cross-sectional area of the connection between the coil 110 and the housing 120. A connection between the coil 110 and the first connection contact 170 of the battery cell 100 comprises at least the first connection 140 and the safety element 130. The latter connection has a cross-sectional area 195, wherein the cross-sectional area 195 can be understood to mean the smallest cross-sectional area of the connection between the coil 110 and the first connection 170.

In one exemplary embodiment the battery cell 100 may have at least one coil 110, wherein the at least one coil 110 can be wound prismatically. In another exemplary embodiment (not shown) the battery cell 100 may have a plurality of coils 110, i.e. at least two coils 110. Here, a safety element 130 can be provided per coil 110. If, in one exemplary embodiment, a plurality of coils 110 are arranged in a battery cell 100, these can be connected to one another in parallel and/or alternatively in series.

A variant of a battery cell 100, in which a contact element 161 is arranged between a first connection 140 of the coil 110 and the housing 120, is also conceivable. Such a variant is reproduced in the schematic illustration from FIG. 1B of an exemplary embodiment of the invention. Here, the contact element 161 is formed as an electrical and thermal conductor or as a thermal conductor and electrical insulator for connecting the coil 110 to the housing 120. The contact element 161 is thus designed as a thermally conductive, but electrically insulating contact element 161 with a cross section 191, wherein the first connection 140 is designed to conduct a flow of heat, which is dependent on an energy storage density of the coil, in a predetermined time from the coil 110, via the contact element 161, to the housing 120, wherein the second connection 150 is electrically insulated from the first connection 140.

FIG. 2 shows a schematic illustration of a prismatic battery cell 100 having four coils 110; 210 in accordance with an exemplary embodiment of the present invention. The battery cell 100 may be a battery cell 100 as described in FIG. 1. It has also already been described that a coil 110; 210 can also be referred to as a cell coil 110; 210. Four coils 110; 210 arranged in parallel and each connected to the housing 120 via a contact element 160 are illustrated in FIG. 2. The housing 120 may be, in one exemplary embodiment, an aluminum housing. The coil arranged in the figure as the second coil from the left and provided with reference sign 210 has a short circuit. The temperature profile over time in the event of a short circuit will be described in greater detail in FIG. 4 and in FIGS. 5a to 5e. The two arrows designated by ‘A’ indicate a plan view of FIG. 2, as illustrated in the subsequent FIG. 3. In one exemplary embodiment the housing 120 may be an aluminum housing.

FIG. 3 shows a schematic illustration of a prismatic battery cell 100 having four coils 110; 210 in a plan view in accordance with one exemplary embodiment of the present invention. The battery cell 100 may be the battery cell 100 shown in FIG. 1. The plan view in FIG. 3 may be a plan view of the battery cell 100 in the direction of the arrows designated in FIG. 2 by ‘A’. Four coils 110; 210 arranged in parallel are arranged in a housing 120. The coils 110; 210 are each connected at one end to the housing 120 via a contact element 160, an electrolyte-free space 360 being located between each of the four contact elements 160. On the side opposite the end of the coils 110; 210 connected to the contact element 160, the coils are interconnected via an insulated collector 370. In accordance with the exemplary embodiment shown in FIG. 1 and not illustrated in FIG. 3, a safety element is arranged between the insulated collector 370 and each of the coils 110; 210. The insulated collector 370 is connected to the first connection contact 170, which is arranged in this exemplary embodiment on the upper side of the housing. The second connection contact 180, which is electrically connected to the housing 120, is likewise arranged on the upper side of the housing, at the other end of the primary extension of the upper side of the housing. The first connection contact 170 and the second connection contact 180 are insulated from one another. The insulated collector 370 can be fabricated from copper in one exemplary embodiment. The insulated collector 370 and the first connection contact 170 are electrically insulated with respect to the housing, for example by means of a plastic film and/or a plastic seal. In one exemplary embodiment the housing 120 and at the same time or alternatively the contact elements 160 is/are fabricated from aluminum or an aluminum alloy.

In other words FIG. 3 shows a plan view of the battery cell 100. In one exemplary embodiment the aluminum collectors of the cathode, i.e. the second connection 150 and/or the contact element 160, are connected over a large area to the housing 120 for improved heat dissipation. The copper collectors of the anode, i.e. the first connection 140, by contrast are electrically insulated from the housing 120 (for example plastic film).

Large cells for automotive battery systems can consist of a number of adjacently arranged cell coils. These are connected in parallel in one exemplary embodiment. One aspect of the presented battery cell is to interrupt this parallel connection using a safety fuse by way of example in the event that there is a short circuit in the coil in question. In one exemplary embodiment the capacitor of the coil is dimensioned such that the heat discharge is large enough to hold the temperature at T<130° C. in the event of a short circuit. A conservative estimation for the expected quantity of heat can be made on the basis of the assumption that the energy E_{runaway} of a fully charged cell released by exothermic reactions is less than the rated capacity in kWh, E_{rated}, i.e.

E_{runaway}<E_{rated}.

In addition, it can be assumed on the basis of “Thermal Abuse Modeling of Li-Ion Cells and Propagation in Modules”, 4^{th} International Symposium for Large Lithium-Ion Battery Technology and Application, AABC 2008, that the release of energy occurs within a time window 10 s<t<30 s. For the presented exemplary embodiment, this means that:

A quantity of heat corresponding to the rated capacity of an individual coil in kWh must be removed within a time t<30 s so that the temperature of the coil in question remains below 130° C.

One aspect of this is the coil capacity in kWh and the heat transfer from coil to housing and surrounding environment. In one exemplary embodiment the aluminum current collectors of the positive electrode are thus attached flat to the aluminum housing, which is likewise at cathode potential. The heat conduction along the aluminum collector film is very high (>100 W/m/K) and penetrates the coil in a planar manner. The heat transfer coefficient from coil to coil, or in the radial direction, is rather low (<5 W/m/K). An even better heat dissipation could be achieved theoretically by attaching the copper collector film to the housing.

However, this is not possible in this exemplary embodiment due to the normal potentials of Al and Cu.

In a further exemplary embodiment (not shown) electrolytes with additions are used for voltage buffering in the event of overload.

FIG. 4 shows a schematic illustration of a prismatic battery cell 100 having four cell coils 110; 210, wherein one cell coil 210 has an internal short circuit, in accordance with an exemplary embodiment of the present invention. The illustrated battery cell 100 may be a battery cell 100 as has been described in FIGS. 1-3. FIG. 4 shows four coils 110; 210, 210 arranged in parallel, wherein the coil 210 has a short circuit. Two arrows 410, 420 show the thermal conductivity in watts per meter and Kelvin between two adjacently arranged coils 110; 210 (arrow 410) and between the coil 210 with short circuit and the housing (arrow 420). The heat profile in the coils 110; 210, 210 is illustrated in FIGS. 5a to 5d. Furthermore, the temperature profile in the housing surrounding the coils 110; 210, 210 is illustrated in FIG. 5e.

FIG. 5a to FIG. 5e show a simulated temperature profile for the battery cell shown in FIG. 4 in accordance with an exemplary embodiment of the present invention. In a Cartesian coordinate system, time in seconds is plotted on the abscissa and the temperature in degrees Celsius is plotted on the ordinate. At the start of the recording the coils 110; 210 have an operating temperature of 35° C. The coil 210 with short-circuit has heated to a temperature of approximately 200° C.

FIG. 4 shows a schematic illustration of a battery cell 100 at 35° C. operating temperature with 4 coils 110; 210, 210, one of which with internal short-circuit (210); a simulated temperature profile in the coils 110; 210, 210 and in the housing 120 is illustrated in FIGS. 5a to 5e illustrated adjacently: here, it can be seen from FIGS. 5a to 5e that coils 110; 210 adjacent to the coil with internal short-circuit (210) are not “ignited”, i.e. that the temperature thereof remains below 130° C. (1<130° C.)

FIGS. 5a, 5c and 5d have a comparable temperature profile. From the start of the recording the temperature rises to a value of approximately 80° C., which is reached after approximately 150 s. The temperature then falls within 1000 s to a value in a tolerance range above the starting temperature in order to then increasingly approximate the starting temperature asymptotically.

FIG. 5b shows the temperature profile of the coil with short circuit. At the start of the recording the temperature lies at approximately 200° C. and then falls within 250 s to a value of approximately 80° C. in order to then approximate the operating temperature of 35° C. asymptotically during the course of the following 3000 s.

In FIG. 5e the temperature of the housing of the battery cell is illustrated. At the start of the recording the temperature of the housing lies at the operating temperature of approximately 35° C. in order to then rise within a time of approximately 150 s to a maximum value of 44° C. After reaching the maximum value the temperature falls again slowly to the original operating temperature, wherein this falls comparatively more quickly in the first 1500 s after reaching the maximum value to a value marginally above the operating temperature, i.e. in a tolerance range above the operating temperature, in order to then approximate the operating temperature asymptotically in the following 1500 s. Here, the tolerance range above the operating temperature is 5° C.

It is clear from FIG. 4 and the associated temperature profile curves in FIGS. 5a to 5e that the temperature in the coils 110; 210 does not rise above 130° C. and that the coils 110; 210 therefore are not affected by the short-circuited coil 210.

FIG. 6 shows a flow diagram of an exemplary embodiment of the present invention as a method 600 for producing a battery cell for a battery for a vehicle having at least one coil. The battery cell is arranged in a housing. The method comprises a step of providing 610 a safety element associated with the coil, which safety element is designed to electrically decouple a first connection of the coil from the battery cell when a predetermined safety criterion is met. The method 600 also comprises a step of arranging 620 a contact element between a second connection of the coil and the housing, wherein the contact element is designed as an electrical and a thermal conductor for connecting the coil to the housing, wherein the contact element has a cross section which is greater than the cross section of the first connection and/or which is designed to conduct a flow of heat, which is dependent on an energy storage density of the coil, in a predetermined time from the coil, via the contact element, to the housing, wherein the second connection is electrically insulated from the first connection. The method 600 also comprises a step 630 of arranging a contact element between a first connection of the coil and the housing, wherein the contact element is designed as an electrical and thermal conductor or as a thermal conductor and electrical insulator for connecting the coil to the housing.

The described exemplary embodiments shown in the figures are selected merely by way of example. Different exemplary embodiments can be combined with one another completely or on the basis of individual features. An exemplary embodiment can also be supplemented by features of a further exemplary embodiment.

Furthermore, method steps according to the invention can be repeated and also performed in an order different from the described order.

If an exemplary embodiment comprises an “and/or” link between a first feature and a second feature, this is to be read such that the exemplary embodiment in accordance with one variant comprises both the first feature and the second feature and in accordance with a further variant comprises either only the first feature or only the second feature.

1. A battery cell for a battery, the battery cell arranged in a housing, and the battery cell comprising:
a coil having a first connection and a second connection electrically insulated from the first connection; and
a first contact element located between the second connection of the coil and the housing, the first contact element formed as an electrical and a thermal conductor or as an electrical insulator and a thermal conductor configured to connect the coil to the housing, the first contact element defining a cross section which is greater than a cross section of the first connection and/or which is configured to conduct a flow of heat, which is dependent on an energy storage density of the coil, in a predetermined time from the coil, via the first contact element, to the housing.

2. The battery cell as claimed in claim 1, further comprising:
a thermally and electrically conductive second contact element or a thermally conductive, but electrically insulating second contact element with a cross section on the first connection, and
wherein the first connection is configured to conduct a flow of heat, which is dependent on an energy storage density of the coil, in a predetermined time from the coil, via the second contact element, to the housing.

3. The battery cell as claimed in claim 1, further comprising:
a safety element associated with the coil and configured to electrically decouple the first connection of the coil from the battery cell when a predetermined safety criterion is met.

4. The battery cell as claimed in claim 1, further comprising:
at least one second coil.

5. The battery cell as claimed in claim 1, wherein:
the first connection of the coil is formed from a first material, and
the second connection of the coil is formed from a second material different from the first material.

6. The battery cell as claimed in claim 1, wherein the second connection of the coil and the housing have the same material properties.

7. The battery cell as claimed in claim 1, wherein a flow of heat conducted in a predefined time via the first contact element corresponds to an energy released in the event of oxidation of contents of the battery cell, at least within a tolerance range.

8. The battery cell as claimed in claim 1, wherein the second connection has a larger cross-sectional area than the first connection.

9. The battery cell as claimed in claim 1, further comprising:
a first connection contact electrically connected to the first connection of the coil and/or a second connection contact electrically connected to the housing and/or to the second connection of the coil,
wherein the first connection contact and the second connection contact are electrically insulated from one another.

10. The battery cell as claimed in claim 1, wherein the housing or at least one side face of the housing is formed as a cooling face or heat sink of the battery cell.

11. The battery cell as claimed in claim 1, wherein the coil is a first coil and the battery cell further comprises:
at least one further coil arranged in the housing and electrically connected in parallel to the first coil,
wherein a first connection of the least one further coil is electrically connected to the first connection of the first coil and a second connection of the at least one further coil is electrically connected to the second connection of the first coil.

12. A method for producing a battery cell for a battery, the battery cell arranged in a housing, the method comprising:
providing a coil having a first connection and a second connection; and
arranging a first contact element between the second connection of the coil and the housing, the first contact element formed as an electrical and a thermal conductor or as an electrical insulator and a thermal conductor for connecting the coil to the housing,
wherein the first contact element has a cross section which is greater than a cross section of the first connection and/or which is configured to conduct a flow of heat, which is dependent on an energy storage density of the coil, in a predetermined time from the coil, via the first contact element, to the housing, and
wherein the second connection is electrically insulated from the first connection.

13. The method as claimed in claim 12, further comprising:
arranging a second contact element between a first connection of the coil and the housing, the second contact element formed as an electrical and thermal conductor or as a thermal conductor and electrical insulator for connecting the coil to the housing.
